(19) United States
(12) Patent Application Publication
(10) Pub. No.: US 2024/0140462 A1
(43) Pub. Date: May 2, 2024

(54) MITIGATION OF LIGHT GLARE DURING DRIVING

(71) Applicant: Ford Global Technologies, LLC, Dearborn, MI (US)

(72) Inventors: Brian Bennie, Sterling Heights, MI (US); David Hiskens, Ann Arbor, MI (US); Collin Hurley, Canton, MI (US); Mark Gehrke, Ypsilanti, MI (US); Jonathan Diedrich, Carleton, MI (US)

(73) Assignee: Ford Global Technologies, LLC, Dearborn, MI (US)

(21) Appl. No.: 18/049,675

(22) Filed: Oct. 26, 2022

(51) Int. Cl. B60W 50/14; B60K 35/00; B60W 40/08

(52) U.S. Cl. CPC B60W 50/14; B60K 35/00; B60W 40/08; B60K 2370/149; B60K 2370/1529; B60K 2370/1868; B60K 2370/27; B60W 2050/146; B60W 2540/225

(57) ABSTRACT

A system for mitigating glare from at least one light source while driving a vehicle. The system includes determining an occurrence of a glare condition based on, at least in part, a visible light video stream generated by a visible light sensor. Upon determining the occurrence of the glare condition, indicia are presented at the vehicle display to assist in navigation of the vehicle.

### BACKGROUND

On bright and sunny days vehicle operators can face glare conditions including excessive light intensity or brightness when driving in the direction of the Sun. When vehicles head east at sunrise or west at sunset, for example, they can face a low Sun angle that can obscure road conditions. In addition to the Sun itself, glare from a wet road, especially during sunny days, can produce similar light conditions. Nighttime driving can cause similar conditions when headlights or high beams from oncoming traffic prevent drivers from effectively seeing the road ahead.

### BRIEF DESCRIPTION OF THE DRAWINGS

FIG. 1 shows an example system for mitigating glare from at least one light source while driving a vehicle.

FIG. 2A shows an example visible light video stream.

FIG. 2B shows an example infrared video steam.

FIG. 2C shows an example blended video stream.

FIG. 3 shows another configuration of a system for mitigating glare from at least one light source while driving a vehicle.

FIGS. 4A-4B show an example method for mitigating glare from at least one light source while driving a vehicle.

### DETAILED DESCRIPTION

The present description discloses systems and methods for mitigating glare from one or more light sources while operating a vehicle. As used herein, glare is a condition where one or more bright lights can reduce the ability of vehicle operators to see the environment ahead of them. Glare can occur, for example, while driving into a sunrise or sunset, while driving at night with oncoming bright lights, or when exiting a tunnel into a brightly lit background scene. A visible light sensor is used to detect a glare condition and present indicators at a vehicle display to assist in vehicle navigation. An infrared video stream can be displayed to a vehicle operator to augment visible light information during a glare condition.

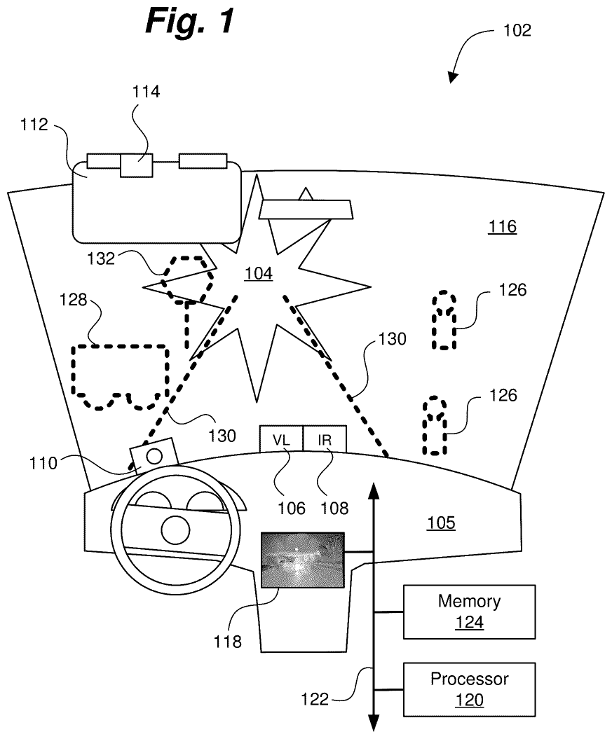

Throughout the description reference is made to FIGS. 1-4B. When referring to the figures, like structures and elements shown throughout are indicated with like reference numerals.

In one example, a system for mitigating glare from at least one light source while driving a vehicle. The system includes a visible light sensor to generate a visible light video stream and a vehicle display to display driving information to a vehicle user. A memory stores instructions executable by a processor. The instructions include instructions to determine in real-time an occurrence of a glare condition based on, at least in part, the visible light video stream. The instructions further include, upon determining the occurrence of the glare condition, presenting indicia at the vehicle display to assist in navigation of the vehicle.

The system may include an infrared sensor to generate an infrared video stream. The instructions may further include instructions to, upon determining the occurrence of the glare condition, present a blended video stream at the vehicle display. The blended video stream presents the infrared video stream as a semi-transparent layer over the visible light video stream.

The indicia may include an indicator of at least one of a pedestrian, a vehicle, a path marking, and a traffic sign in front of the vehicle. An infrared sensor may be used to generate an infrared video stream and the instructions further include instructions to identify at least one region in the visible light video stream potentially obscured by the light source. The indicia may include at least a portion of the infrared video stream corresponding to the region in the visible light video stream potentially obscured by the light source.

The instructions may further include instructions to generate a blended video stream and to present the blended video stream on the vehicle display upon determining the occurrence of the glare condition. The blended video stream combines the visible light video stream and the infrared video stream such that the portion of the infrared video stream corresponding to the region in the visible light video stream potentially obscured by the light source is layered over the visible light video stream.

The visible video stream may include an image frame. The region in the visible light video stream potentially obscured by the light source may be defined by a continuous area extending from the light source with a color saturation above a threshold saturation level.

The glare condition can be based on, at least in part, determining a vertical position of the light source in the visible light video stream is below a height threshold. The glare condition may be based on a detection that the vehicle user's eyes are partially closed. The instructions may include instructions to detect when the vehicle user's eyes are partially closed based on the vehicle interior video stream. The system may include a sun visor sensor to detect when a sun visor is positioned in a shading position, and the glare condition may be based on the sun visor positioned in the shading position.

Another implementation may include a method for mitigating glare from at least one light source while driving. The method includes determining in real-time an occurrence of a glare condition based on, at least in part, a visible light video stream generated by a visible light sensor. Upon determining the occurrence of the glare condition, the method includes presenting indicia at the vehicle display to assist in navigation of the vehicle.

The method may include determining the occurrence of the glare condition. A presenting step presents a blended video stream at the vehicle display. The blended video stream presents an infrared video stream from an infrared sensor as a semi-transparent layer over the visible light video stream.

The vehicle display may be a heads-up display positioned in a user field of view. The indicia may include an indicator of a pedestrian, a vehicle, a path marking, and/or a traffic sign in front of the vehicle.

The method may include identifying at least one region in the visible light video stream potentially obscured by the light source. The indicia may include at least a portion of an infrared video stream corresponding to the region in the visible light video stream potentially obscured by the light source. The infrared video stream may be generated by an infrared sensor.

The method may include generating a blended video stream. The blended video stream combines the visible light video stream and the infrared video stream such that the portion of the infrared video stream corresponding to the region in the visible light video stream potentially obscured by the light source is layered over the visible light video stream. A presenting step presents the blended video stream on the vehicle display upon determining the occurrence of the glare condition.

The visible light video stream may include an image frame. The region in the visible light video stream potentially obscured by the light source may be defined by a continuous area extending from the light source with a color saturation above a threshold saturation level.

The glare condition may be based on, at least in part, determining a vertical position of the light source in the visible light video stream is below a height threshold. The method may include detecting when the vehicle user's eyes are partially closed, and the glare condition may be further based on a detection that the vehicle user's eyes are partially closed. The glare condition may be further based on a sun visor positioned in the shading position.

Another implementation may include a computer program product for mitigating glare from at least one light source while driving. The computer program product includes computer readable program code configured to determine in real-time an occurrence of a glare condition based on, at least in part, a visible light video stream generated by a visible light sensor, and, upon determining the occurrence of the glare condition, present indicia at the vehicle display to assist in navigation of the vehicle. The indicia may include an indicator of a pedestrian, a vehicle, a path marking, and/or a traffic sign in front of the vehicle.

FIG. 1 shows an example system 102 for mitigating glare from at least one light source 104 while driving a vehicle 105. The system 102 includes a forward-facing, visible light sensor 106 configured to generate a visible light video stream of the environment ahead. In one arrangement the visible light sensor 106 is a visible light camera with a color sensor array configured to capture visible light radiation.

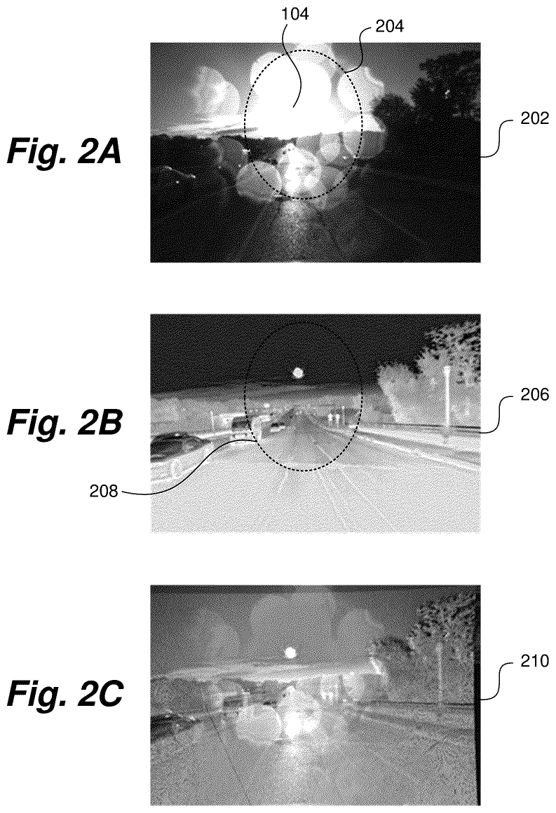

FIG. 2A shows an example visible light video stream 202 received from the visible light sensor 106. The visible light video stream 202 can include a series of image frames that, when viewed in a sequence, create the visible light video stream 202. The visible light sensor 106 provides the visible light video stream 202 in real-time or near real-time such that the images presented by the visible light sensor 106 appear to capture scenes at approximately the same time as they occur in the real world. As discussed in more detail below, the visible light video stream 202 may include a region 204 potentially obscured by the light source 104.

Returning to FIG. 1, the system 102 can include a forward-facing, infrared sensor 108 configured to generate an infrared video stream. FIG. 2B shows an example a real-time, infrared video stream 206 received from the infrared sensor 108. The infrared video stream 206 can include a series of image frames that, when viewed in a continuous sequence, create the infrared video stream 206. A portion 208 of the infrared video stream 206 may correspond to the region 204 in the visible light video stream 202 potentially obscured by the light source 104. In one arrangement the infrared sensor 108 is an infrared camera with a sensor array configured to capture far-infrared radiation. Infrared radiation detected by the sensor array may be mapped to gray scale, creating a gray scale image of the detected infrared radiation.

The system 102 can include a vehicle interior camera 110 directed at the vehicle cabin and configured to generate a vehicle interior video stream. The interior camera 110 can capture images of the vehicle user, such as the driver's face. The system 102 can also include a sun visor 112 and a sun visor sensor 114 to detect when the sun visor 112 is positioned in a shading position. The sun visor sensor 114 may be, for example, a mechanical switch or a reed switch configured to activate when the sun visor 112 is lowered to a shading position.

Various other vehicle sensors may provide operational data of the vehicle 105, for example, wheel speed, wheel orientation, and engine and transmission data (e.g., temperature, fuel consumption, etc.). The sensors may detect the location and/or orientation of the vehicle 105. For example, the sensors may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors may detect the external world, e.g., the objects and/or characteristics of surroundings of the vehicle 105, such as other vehicles, road lane markings, traffic lights and/or signs, pedestrians, etc. For example, the sensors may include radar sensors, scanning laser range finders, light detection and ranging (LIDAR) devices, and image processing sensors such as cameras, including the visible light sensor 106 and/or the infrared sensor 108.

The system 102 may include one or more vehicle displays to show driving information to the vehicle user. In one configuration, the vehicle display is a heads-up display 116. The heads-up display 116 can be a transparent display positioned in the vehicle user's field of view. In a particular configuration the vehicle's windshield is utilized as a heads-up display 116. The vehicle display may include a console display 118. The vehicle displays can be connected to a computer processor 120 through a communications network 122.

The computer processor 120 may be a microprocessor-based computing device, e.g., a generic computing device including an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. Memory 124 can include media for storing instructions executable by the computer processor 120 as well as for electronically storing data and/or databases, and/or the computer processor 120 can include structures such as the foregoing by which programming is provided. The computer processor 120 can be multiple computer processors coupled together.

Data and commands may be transmitted and received through the communications network 122. The communications network may be, for example, a controller area network (CAN) bus, Ethernet, WiFi, Local Interconnect Network (LIN), onboard diagnostics connector (OBD-II), and/or by any other wired or wireless communications network. The computer processor 120 may be communicatively coupled to the displays, sensors, the memory 124, and other components via the communications network 122.

The memory 124 can be of any type, e.g., hard disk drives, solid state drives, servers, or any volatile or non-volatile media. The memory 124 can store the collected data sent from the vehicle sensors. The memory 124 can be a separate device from the computer processor 120, and the computer processor 120 can retrieve information stored by the memory via the communications network 122. Alternatively or additionally, the memory 124 can be part of the computer processor 120.

The memory 124 can store instructions executable by the processor 120. These instructions include instructions to determine, in real-time, an occurrence of a glare condition based on the visible light video stream from the visible light sensor 106. The glare condition can be based on, at least in part, the visible light video stream from the visible light sensor 106.

For example, the computer processor 120 may analyze the dynamic range of visible light video stream. When the visible light video stream consists of very bright regions with little visual information it may indicate that a glare condition is occurring. The instructions may include determining that a vertical position of the light source 104 in the visible light video stream is below a height threshold with respect to the top boarder of the visible light video stream. For example, when a light source 104 is detected to be greater than a specified amount, e.g., 300 pixels, below the top border of the visible light video stream, a glare condition may be indicated. Thus, when the light source 104 is determined to be close to level with the vehicle user's eyes, this may indicate a glare condition is occurring.

It is contemplated that other techniques for determining the occurrence of a glare condition may be used. For example, Andalibi et al., “Automatic Glare Detection via Photometric, Geometric, and Global Positioning Information”, Proc. IS&T Int'l. Symp. on Electronic Imaging: Autonomous Vehicles and Machines, https://doi.org/10.2352/ISSN.2470-1173.2017.19.AVM-024, pp. 77-82 (2017), describes an algorithm for real-time automatic glare detection. Esfahani et al., “Robust Glare Detection: Review, Analysis, and Data Release”, eprint arXiv:2110.06006. pp. 1-6 (October 2021), proposes a modified version of U-Net multi-branch network architecture to detect a glare condition.

The glare condition can be determined to occur based on additional or alternative conditions. For example, the memory 124 may include instructions to detect when the vehicle operator's eyes are squinting. The vehicle operator's eyes can be detected using the vehicle interior video stream from the vehicle interior camera 110. When the vehicle operator's eyes are narrowed or partially closed for a predetermined length of time, the glare condition may be considered to occur. Partially closed eyes may be determined, for example, using image processing to isolate and measure the vehicle operator's sclera. The current sclera measurement is compared to historical sclera measurements. If the current sclera measurements are less than 50% of the historical sclera measurements for at least 30 seconds, the vehicle operator may be considered to be squinting.

The glare condition can be determined to occur based on the sun visor 112 position. In particular, the computer processor 120 may be programmed to read the sun visor sensor 114 and detect when the sun visor 112 is flipped down to the shading position.

In one configuration, the glare condition may be based on, at least in part, a frame saturation level exceeding a frame saturation threshold. In particular, image frames in the visible light video stream 202 are analyzed to determine the number of pixels in an image frame above a pixel saturation threshold. For example, the pixel saturation Sat_{(x,y)} at a given pixel location (x,y) may be determined by:

Sat_{(x,y)}=255−[max(R_{(x,y)},G_{(x,y)},B_{(x,y)})−G_{(x,y)},B_{(x,y)})],
where max is the maximum function and min is the minimum function. Other known techniques for determining pixel saturation may be used. The frame saturation level may be proportional to the number of pixels in the image frame above the pixel saturation threshold.

The instructions may cause, upon determining the occurrence of the glare condition, the computer processor 120 to present indicia at the vehicle display to assist in vehicle navigation. The indicia may include, for example, an indicator of a pedestrian 126, another vehicle 128, a path marking 130, and/or a traffic sign 132 in front of the vehicle 105. The indicia may be presented at the heads-up display 116 and/or the console display 118. As discussed above, the vehicle 105 may include various sensors, such as radar sensors, scanning laser range finders, LIDAR devices, and/or image processing sensors to identify the indicia presented to the vehicle user.

In one configuration, the instructions may cause, upon determining the occurrence of the glare condition, the computer processor 120 to present a blended video stream at the vehicle display. As shown in FIG. 2C, the blended video stream 210 presents the infrared video stream 206 as a semi-transparent layer over the visible light video stream 202. In this manner, some details lost in the visible light video stream 202 due to glare are provided by the infrared video stream 206. The infrared video stream 206 and visible light video stream 202 blending can be done where the same proportion of the infrared video stream 206 is used uniformly throughout the blended video stream 210. Alternatively, the blending can be tailored such that a higher proportion of the infrared video stream 206 is used in regions where the visible light video stream 202 is saturated.

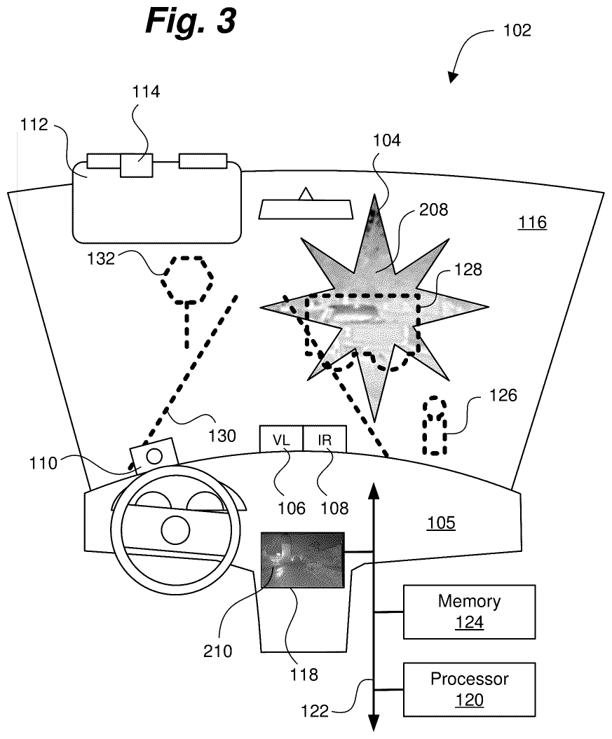

FIG. 3 shows another configuration where the indicia may include the infrared video stream from the infrared sensor 108, or a part thereof.

The instructions may cause the computer processor 120 to identify at least one region 204 in the visible light video stream potentially obscured by the light source 104. For example, the region 204 in the visible light video stream potentially obscured by the light source 104 may be defined by a continuous area extending from the light source 104 with a color saturation above a threshold saturation level.

The memory 124 includes instructions to present the portion 208 of the infrared video stream corresponding to the region 204 in the visible light video stream 202 potentially obscured by the light source 104. In other words, the indicia include at least a portion 208 of the infrared video stream 206 corresponding to the region 204 in the visible light video stream 202 potentially obscured by the light source 104.

It is contemplated that different vehicle displays may provide different images to mitigate glare. For example, the console display 118 may present the blended video stream 210, while the heads-up display 116 may present the portion 208 of the infrared video stream 206 corresponding to the region 204 in the visible light video stream 202 potentially obscured by the light source 104.

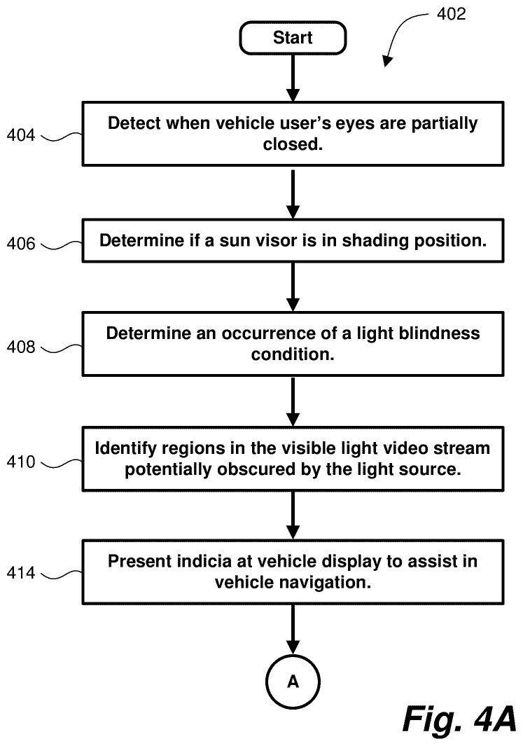

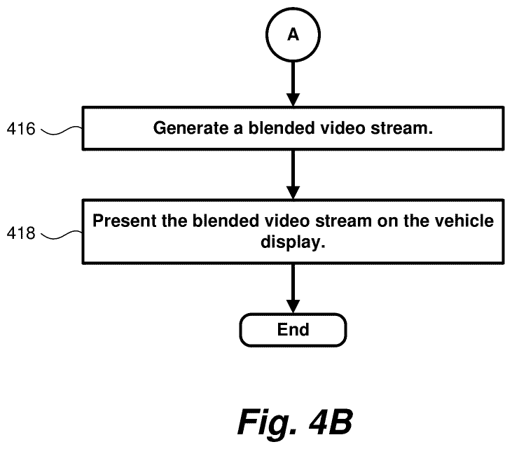

FIGS. 4A and 4B show an example method 402 for mitigating glare from one or more light sources 104 while driving. As mentioned, memory 124 in the vehicle 105 may store executable instructions for performing the method steps described below.

The method 402 includes detecting operation 404. During this operation, an interior video stream from an interior camera is used to detect when the vehicle user's eyes are partially closed. After detecting operation 404, control passes to determining operation 406.

At determining operation 406, a sun visor sensor 114 is used to determine if a sun visor 112 is positioned in the shading position. After determining operation 406, control passes to determining operation 408.

At determining operation 408, an occurrence of a glare condition is determined. As discussed above, the vehicle 105 is equipped with various sensors, including a visible light sensor 106 that generates a visible light video stream 202. The determining operation 408 may be based, at least in part, the visible light video stream 202. For example, a determination that a glare condition is present may be based on determining that a vertical position of the light source 104 in the visible light video stream 202 is below a height threshold.

The glare condition may be determined based on other techniques such as mentioned above and/or other factors, such as on a detection that the vehicle user's eyes are partially closed for a duration of time, such as 30 seconds. This condition may indicate the vehicle user is squinting in reaction to glare from a bright light source low to the horizon, such as the Sun or vehicle headlights. The glare condition may be determined based on the sun visor 112 positioned in the shading position.

As discussed above the glare condition may be based on, at least in part, a frame saturation level exceeding a frame saturation threshold. In particular, image frames in the visible light video stream 202 are analyzed to determine the number of pixels in an image frame above a pixel saturation threshold. If the number of pixels in the image frame exceeds the pixel saturation threshold, a glare condition may be determined. After determining operation 408, control passes to identifying operation 410.

At identifying operation 410, at least one region 204 in the visible light video stream 202 is identified as potentially obscured by the light source 104. For example, the region 204 in the visible light video stream 202 potentially obscured by the light source 104 is defined by a continuous area extending from the light source with a color saturation above a threshold saturation level. After identifying operation 410, control passes to presenting operation 414.

At presenting operation 414, indicia are presented at the vehicle display to assist in navigation of the vehicle 105 upon determining the occurrence of the glare condition. As earlier discussed, the vehicle display may be a heads-up display 116 positioned in a user field of view. The vehicle display may additionally or alternatively include a console display 118. The indicia may include an indicator of a pedestrian 126, a vehicle 128, a path marking 130, and/or a traffic sign 132 in front of the vehicle 105. Vehicle sensors, such as radar sensors, scanning laser range finders, LIDAR devices, and/or image processing sensors can be used to identify the indicia presented to the vehicle user.

In one configuration, the indicia include at least a portion 208 of an infrared video stream 206 corresponding to the region 204 in the visible light video stream 202 potentially obscured by the light source 104. After presenting operation 414, control passes to generating operation 416.

At generating operation 416, a blended video stream 210 is generated. In one implementation, the blended video stream combines the visible light video stream 202 and the infrared video stream 206 such that a portion 208 of the infrared video stream 206 corresponding to the region 204 in the visible light video stream 202 potentially obscured by the light source 104 is layered over the visible light video stream 202. In one configuration, the blended video stream 210 includes the infrared video stream 206 from the infrared sensor 108 as a semi-transparent layer over the visible light video stream 202.

In one implementation, alignment of the infrared video stream 206 and visible light video stream 202 can be accomplished via a single look up table (LUT) based interpolation. The single interpolation includes resizing the lower resolution image by a factor determined so that the instantaneous field of view (IFOV=pixel pitch/focal length) of the resized low-resolution video matches the IFOV of the higher resolution video; distortion correction of the low-resolution image; and resampling to shift the low-resolution video for better alignment with the high-resolution video.

The first two operations accomplished by the LUT are derived from basic sensor parameters (IFOV) and distortion correction parameters on a per-camera basis provided by the camera manufacturer or as measured. The third operation is determined by a calibration process involving matching features from a synthetic target designed to have discernable features for all cameras which are to be aligned.

Since the lookup table is static, the level of fidelity is determined by the specific calibration data chosen to determine the resampling (both the distance to the calibration target and the vertical location of the target in the field of view). Objects may be best aligned when their distance and location in the field of view matches the distance to the target during calibration. When the object location (distance and field of view position) is not matched to the calibration, misalignment may result. The requirements of the specific application can determine if the level of residual misregistration is adequate for that application. After generating operation 416, control passes to presenting operation 418.

At presenting operation 418, the blended video stream 210 is presented on the vehicle display upon determining the occurrence of the glare condition. For example, the blended video stream 210 may be presented at the console display 118.

The descriptions of the various examples and implementations have been presented for purposes of illustration but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical enhancements over technologies found in the marketplace, or to enable others of ordinary skill in the art to understand the implementations disclosed herein.

As will be appreciated, the methods and systems described may be implemented as a computer program product. The computer program product may include a computer readable storage medium (or media) having computer readable program instructions thereon for causing a processor to carry out operations discussed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry.

Various implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system comprising:
a computing device that includes a processor and a memory, the memory storing instructions executable by the processor, including instructions to:
determine an occurrence of a glare condition based on, at least in part, a visible light video stream from a visible light sensor; and
upon determining the occurrence of the glare condition, output indicia at a vehicle display to a vehicle operator.

2. The system of claim 1, wherein the indicia include an indicator of at least one of a pedestrian, a vehicle, a path marking, and a traffic sign.

3. The system of claim 1, wherein the instructions further include instructions to, upon determining the occurrence of the glare condition, present a blended video stream at the vehicle display, the blended video stream presenting an infrared video stream from an infrared sensor as a semi-transparent layer over the visible light video stream.

4. The system of claim 1, further comprising:
wherein the instructions further include instructions to identify at least one region in the visible light video stream potentially obscured by a light source; and
wherein the indicia include at least a portion of an infrared video stream from an infrared sensor corresponding to the region in the visible light video stream potentially obscured by the light source.

5. The system of claim 4, wherein the instructions further include instructions to:
generate a blended video stream, the blended video stream combining the visible light video stream and the infrared video stream such that the portion of the infrared video stream corresponding to the region in the visible light video stream potentially obscured by the light source is layered over the visible light video stream; and
present the blended video stream on the vehicle display upon determining the occurrence of the glare condition.

6. The system of claim 4, further comprising:
wherein the visible video stream includes an image frame; and
wherein the region in the visible light video stream potentially obscured by the light source is defined by a continuous area extending from the light source with a color saturation above a threshold saturation level.

7. The system of claim 1, wherein the glare condition is based on, at least in part, determining a vertical position of a light source in the visible light video stream is below a height threshold.

8. The system of claim 1, further comprising:
wherein the instructions further include instructions to detect when a vehicle user's eyes are partially closed based on a vehicle interior video stream; and
wherein the glare condition is further based on a detection that the vehicle user's eyes are partially closed.

9. The system of claim 1, further comprising:
a sun visor sensor to detect when a sun visor is positioned in a shading position; and
wherein the glare condition is further based on the sun visor positioned in the shading position.

10. The system of claim 1, further comprising:
wherein the visible light video stream includes an image frame;
wherein the glare condition is based on, at least in part, a frame saturation level exceeding a frame saturation threshold, the frame saturation level being proportional to a count of pixels in the image frame above a pixel saturation threshold.

11. A method comprising:
determining an occurrence of a glare condition based on, at least in part, a visible light video stream generated by a visible light sensor; and
upon determining the occurrence of the glare condition, presenting indicia at a vehicle display to assist in navigation of the vehicle.

12. The method of claim 11, further comprising upon determining the occurrence of the glare condition, presenting a blended video stream at the vehicle display, the blended video stream presenting an infrared video stream from an infrared sensor as a semi-transparent layer over the visible light video stream.

13. The method of claim 11, further comprising:
wherein the vehicle display is a heads-up display positioned in a user field of view; and
wherein the indicia include an indicator of at least one of a pedestrian, a vehicle, a path marking, and a traffic sign in front of the vehicle.

14. The method of claim 11, further comprising:
identifying at least one region in the visible light video stream potentially obscured by a light source; and
wherein the indicia include at least a portion of an infrared video stream corresponding to the region in the visible light video stream potentially obscured by the light source, the infrared video stream generated by an infrared sensor.

15. The method of claim 14, further comprising:
generating a blended video stream, the blended video stream combining the visible light video stream and the infrared video stream such that the portion of the infrared video stream corresponding to the region in the visible light video stream potentially obscured by the light source is layered over the visible light video stream; and
presenting the blended video stream on the vehicle display upon determining the occurrence of the glare condition.

16. The method of claim 14, further comprising:
wherein the visible light video stream includes an image frame; and
wherein the region in the visible light video stream potentially obscured by the light source is defined by a continuous area extending from the light source with a color saturation above a threshold saturation level.

17. The method of claim 11, wherein the glare condition is based on, at least in part, determining a vertical position of a light source in the visible light video stream is below a height threshold.

18. The method of claim 11, further comprising:
detecting when a vehicle user's eyes are partially closed; and
wherein the glare condition is further based on a detection that the vehicle user's eyes are partially closed.

19. The method of claim 11, wherein the glare condition is further based on a sun visor positioned in a shading position.

20. A computer program product comprising:
a non-transitory computer readable storage medium having computer readable program code embodied therewith, the computer readable program code configured to:
determine an occurrence of a glare condition based on, at least in part, a visible light video stream generated by a visible light sensor; and
upon determining the occurrence of the glare condition, present indicia at a vehicle display to assist in navigation of the vehicle.
